(19) United States
(12) Patent Application Publication
(10) Pub. No.: US 2026/0045847 A1
(43) Pub. Date: Feb. 12, 2026

(54) STATOR

(71) Applicant: DENSO CORPORATION, Kariya-city (JP)

(72) Inventors: Kandai NAGATA, Kariya-city (JP); Naoto NATSUME, Kariya-city (JP); Masayuki ECHIZEN, Kariya-city (JP); Masayuki TAKAHASHI, Kariya-city (JP); Ryo MITANI, Kariya-city (JP)

(73) Assignee: DENSO CORPORATION, Kariya-city (JP)

(21) Appl. No.: 19/361,139

(22) Filed: Oct. 17, 2025

Related U.S. Application Data
(63) Continuation of application No. PCT/JP2024/002890, filed on Jan. 30, 2024.

(30) Foreign Application Priority Data
Apr. 17, 2023 (JP) 2023-067463

(51) Int. Cl. H02K 3/52

(52) U.S. Cl. CPC H02K 3/522; H02K 2203/12

(57) ABSTRACT

A stator includes: a stator core having a plurality of tooth parts extending in a radial fashion; insulators formed of resin and mounted to the stator core; and coil winding parts each of which is wound on a corresponding one of the tooth parts of the stator core via a corresponding one of the insulators. Moreover, between the stator core and each of the coil winding parts, there is provided an insulating layer that has a lower permittivity than the insulators.

### CROSS-REFERENCE TO RELATED APPLICATIONS

The present application is a continuation application of International Application No. PCT/JP2024/002890 filed on Jan. 30, 2024, which is based on and claims priority from Japanese Patent Application No. 2023-067463 filed on Apr. 17, 2023. The entire contents of these applications are incorporated by reference into the present application.

### BACKGROUND

### 1 Technical Field

The present disclosure relates to stators.

### 2 Description of Related Art

Conventionally, stators have been known which include a stator core having a plurality of tooth parts extending in a radial fashion, insulators formed of resin and mounted to the stator core, and coil winding parts wound on the respective tooth parts via the respective insulators. Moreover, the known stators include those in which insulating films are provided between the tooth parts and the coil winding parts (see, for example, Japanese Patent Application Publication No. JP 2018-198515 A).

### SUMMARY

As a result of a detailed investigation by the inventors of the present application, it has been found that the aforementioned related art has a problem that when a high voltage is applied to the coil winding parts, puncture may occur in the insulating films. It is conceivable to increase the thicknesses of resin portions of the insulators which are provided between the tooth parts and the coil winding parts so as to withstand the high voltage. However, in this case, there is another problem that the size of the stator may increase with increase in the thicknesses of the resin portions of the insulators.

The present disclosure has been accomplished in view of the above problems.

According to the present disclosure, there is provided a stator which includes: a stator core having a plurality of tooth parts extending in a radial fashion; insulators formed of resin and mounted to the stator core; and coil winding parts each of which is wound on a corresponding one of the tooth parts of the stator core via a corresponding one of the insulators. Moreover, between the stator core and each of the coil winding parts, there is provided an insulating layer that has a lower permittivity than the insulators.

With the above configuration, it becomes possible to secure insulation of the stator core from the coil winding parts while enabling suppression of increase in the size of the stator.

### BRIEF DESCRIPTION OF THE DRAWINGS

FIG. 1 is a plan view of a stator according to a first embodiment.

FIG. 2 is a perspective view of a stator constituent member according to the first embodiment.

FIG. 3 is a plan cross-sectional view of the stator constituent member according to the first embodiment.

FIG. 4 is a longitudinal cross-sectional view of the stator constituent member according to the first embodiment.

FIG. 5 is a longitudinal cross-sectional view schematically showing the stator constituent member according to the first embodiment.

FIG. 6 is a perspective view showing part of an insulator according to the first embodiment.

FIG. 7 is a plan cross-sectional view showing part of the stator constituent member according to the first embodiment.

FIG. 8 is a schematic diagram illustrating the voltage division between a stator core and a coil winding part.

FIG. 9 is a graph illustrating an example of Paschen's curves.

FIG. 10 is a longitudinal cross-sectional view schematically showing a stator constituent member according to a second embodiment.

FIG. 11 is a longitudinal cross-sectional view schematically showing a stator constituent member according to a third embodiment.

FIG. 12 is a longitudinal cross-sectional view schematically showing a stator constituent member according to a fourth embodiment.

FIG. 13 is a longitudinal cross-sectional view schematically showing a stator constituent member according to a fifth embodiment.

FIG. 14 is a longitudinal cross-sectional view schematically showing a stator constituent member according to a sixth embodiment.

FIG. 15 is a longitudinal cross-sectional view schematically showing part of a stator constituent member according to a seventh embodiment.

FIG. 16 is a longitudinal cross-sectional view schematically showing part of a stator constituent member according to an eighth embodiment.

FIG. 17 is a longitudinal cross-sectional view schematically showing part of a stator constituent member according to a ninth embodiment.

### DESCRIPTION OF EMBODIMENTS

### First Embodiment

First, a first embodiment of the present disclosure will be described.

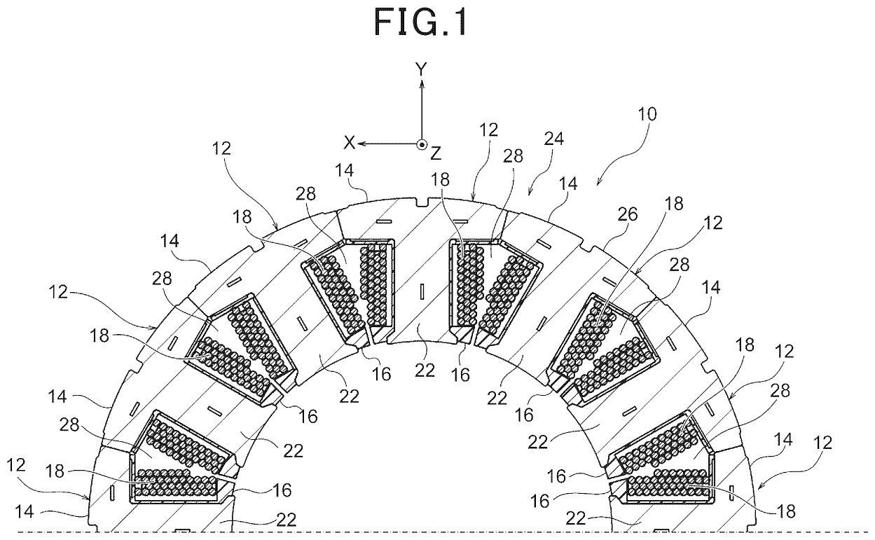

As shown in FIG. 1, a stator 10 according to the first embodiment includes a plurality of stator constituent members 12. The stator 10 is formed by assembling the stator constituent members 12 into an annular shape. FIG. 1 shows half of the stator 10. The stator 10 is applied to a brushless motor. Brushless motors may be used in any application. Examples of brushless motors include fan motors, pump drive motors and compressor motors.

It should be noted that in each figure, the X direction represents a tangential direction of the stator 10; the Y direction represents a radial direction of the stator 10; and the Z direction represents an axial direction of the stator 10. It also should be noted that the tangential, radial and axial directions of a stator core 24 that will be described later are respectively the same as the tangential, radial and axial directions of the stator 10.

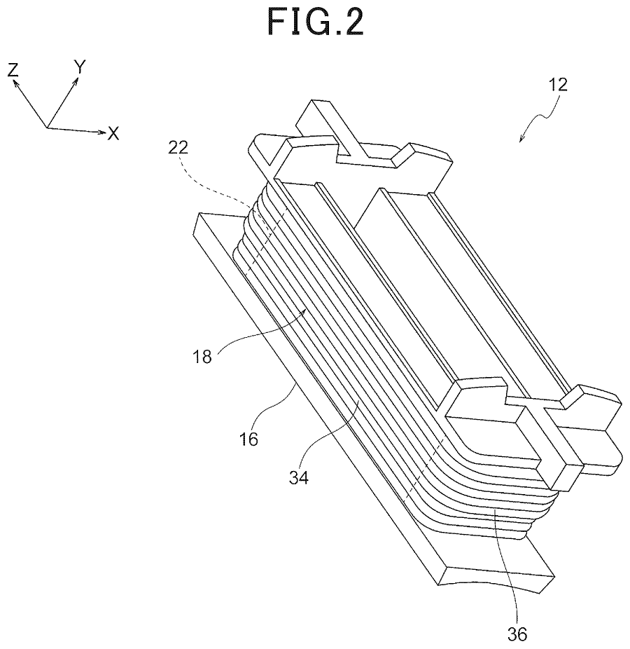

As shown in FIGS. 1 to 3, each stator constituent member 12 includes a core member 14, an insulator 16 and a coil winding part 18. The core member 14 has an umbrella part 20 and a tooth part 22. The umbrella part 20 extends in the X direction; and the tooth part 22 extends, from a central portion of the umbrella part 20, inward in the Y direction. The stator core 24 (see FIG. 1) is formed by assembling the core members 14 into an annular shape. In the state of the stator core 24 having been formed, the umbrella parts 20 of the core members 14 together form an annular part 26 (see FIG. 1) of the stator core 24; and the tooth parts 22 of the core members 14 extend in a radial fashion around a central axis of the stator core 24. Between the tooth parts 22, there are formed slots 28.

In addition, the configuration of each stator constituent member 12 including its details is not strictly symmetrical in the X direction when viewed in the Z direction. However, for the sake of convenience, the configuration of only half of each stator constituent member 12 in the X direction will be described hereinafter on the assumption that the main configuration of each stator constituent member 12 is symmetrical in the X direction when viewed in the Z direction.

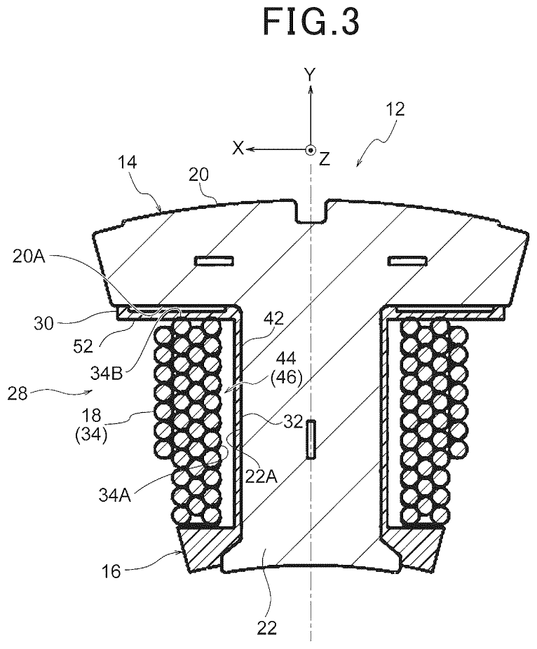

As shown in FIG. 3, in each stator constituent member 12, the umbrella part 20 of the core member 14 has an inner surface 20A; and the tooth part 22 of the core member 14 has a side surface 22A. The inner surface 20A of the umbrella part 20 extends in both the X and Z directions and faces inward in the Y direction. On the other hand, the side surface 22A of the tooth part 22 extends in both the Y and Z directions and faces in the X direction. Moreover, both the inner surface 20A of the umbrella part 20 and the side surface 22A of the tooth part 22 adjoin a corresponding one of the slots 28.

The insulator 16 is mounted to the core member 14. The insulator 16 is formed of resin. The resin forming the insulator 16 may be any resin. Examples of the resin forming the insulator 16 include polyimide, polyamide, polyphenylene sulfide (PPS) and polybutylene terephthalate (PBT). The insulator 16 has an inner wall portion 30 and a side wall portion 32. The inner wall portion 30 covers the inner surface 20A of the umbrella part 20 of the core member 14, while the side wall portion 32 covers the side surface 22A of the tooth part 22 of the core member 14. Moreover, both the inner wall portion 30 and the side wall portion 32 are located in a corresponding one of the slots 28.

The coil winding part 18 is wound on the tooth part 22 of the core member 14 via the insulator 16. The coil winding part 18 is formed by winding a coil with respect to the tooth part 22 around the Y direction. The coil that forms the coil winding part 18 may have only one coil winding part 18 wound on one tooth part 22, or have a plurality of coil winding parts 18 wound respectively on a plurality of tooth parts 22.

The coil winding part 18 has an axial portion 34 that extends in the Z direction. The axial portion 34 is inserted in a corresponding one of the slots 28. The axial portion 34 has a side surface 34A and an end surface 34B. The side surface 34A is a surface (i.e., an inner side surface) of the axial portion 34 which is formed on the tooth part 22 side. On the other hand, the end surface 34B is a surface of the axial portion 34 which is formed on the umbrella part 20 side. The side wall portion 32 of the insulator 16 is interposed between the side surface 34A of the axial portion 34 of the coil winding part 18 and the side surface 22A of the tooth part 22 of the core member 14, while the inner wall portion 30 of the insulator 16 is interposed between the end surface 34B of the axial portion 34 of the coil winding part 18 and the inner surface 20A of the umbrella part 20 of the core member 14.

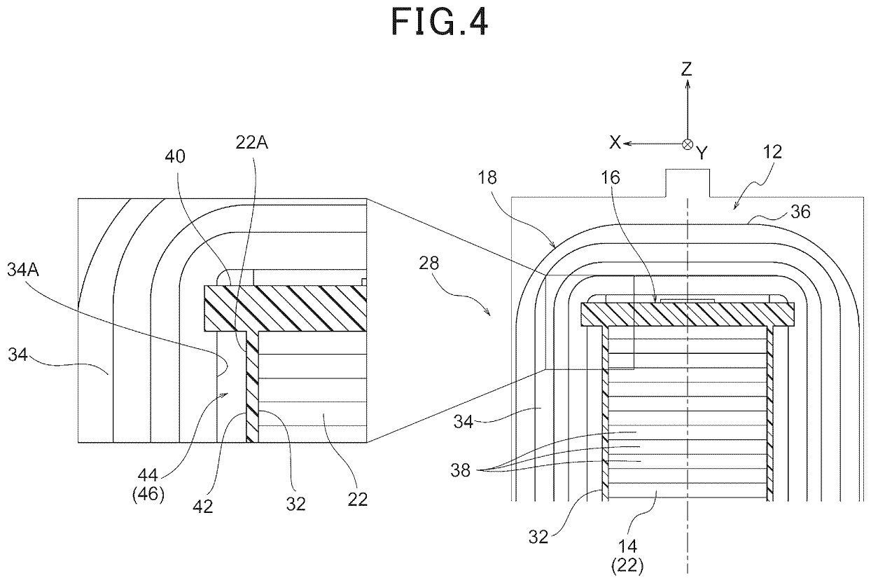

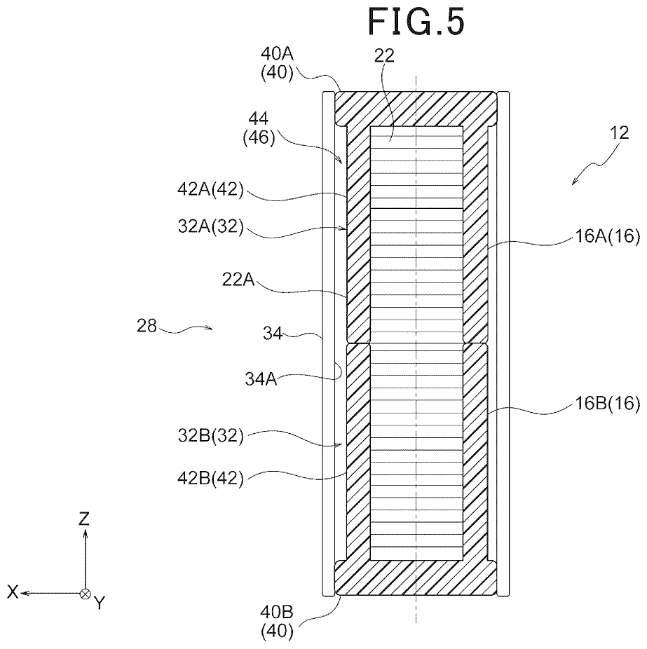

As shown in FIGS. 4 and 5, the coil winding part 18 also has a tangential portion 36 that extends in the X direction in addition to the axial portion 34. The tangential portion 36 is connected with the axial portion 34. The core member 14 is formed of a plurality of core sheets 38 that are laminated in the Z direction. The insulator 16 is divided in the Z direction into a first insulator 16A and a second insulator 16B. The side wall portion 32 of the insulator 16 is constituted of a first side wall portion 32A formed in the first insulator 16A and a second side wall portion 32B formed in the second insulator 16B. The first side wall portion 32 and the second side wall portion 32 are connected in the Z direction.

The side wall portion 32 of the insulator 16 extends in both the Y and Z directions along the axial portion 34 of the coil winding part 18. The side wall portion 32 includes a pair of protruding portions 40 and a resin portion 42. The resin portion 42 is constituted of a first resin portion 42A formed in the first side wall portion 32A and a second resin portion 42B formed in the second side wall portion 32B. Of the pair of protruding portions 40, a protruding portion 40A is formed at one end of the side wall portion 32 in the Z direction, whereas a protruding portion 40B is formed at the other end of the side wall portion 32 in the Z direction. The resin portion 42 is formed of that part of the side wall portion 32 which is located between the protruding portion 40A and the protruding portion 40B.

The pair of protruding portions 40 each protrude from the resin portion 42 toward the axial portion 34 of the coil winding part 18. Moreover, the pair of protruding portions 40 are each formed in the shape of a rib extending in the Y direction. Furthermore, the pair of protruding portions 40 each abut against the side surface 34A of the axial portion 34 of the coil winding part 18, thereby forming a gap 44 between the resin portion 42 and the axial portion 34. The gap 44 is filled with air; and an insulating layer 46 is formed by the air filled in the gap 44. Thus, between the side surface 22A of the tooth part 22 of the core member 14 and the side surface 34A of the axial portion 34 of the coil winding part 18, there is provided, in addition to the resin portion 42, the insulating layer 46 that is formed between the resin portion 42 and the axial portion 34 of the coil winding part 18.

Both the resin portion 42 and the insulating layer 46 are provided in a corresponding one of the slots 28. The insulating layer 46 formed of air is an insulator which has a lower permittivity (in other words, has a lower volume resistivity) than the insulator 16. Permittivity is a constant represented by ¿, which will be described later. Volume resistivity is the electrical resistance value per unit volume.

In addition, the insulating layer 46 may be formed of any material which has a lower permittivity than the insulator 16, regardless of whether it is in the form of gas, fluid, or solid. Examples of the material forming the insulating layer 46 include air, a refrigerant (e.g., a mixed refrigerant or a natural refrigerant), an oil (e.g., a refrigeration oil, a grease or an automatic transmission fluid), a resin (e.g., an insulating paper, a formed product, a molded product, a tube or a string) and rubber.

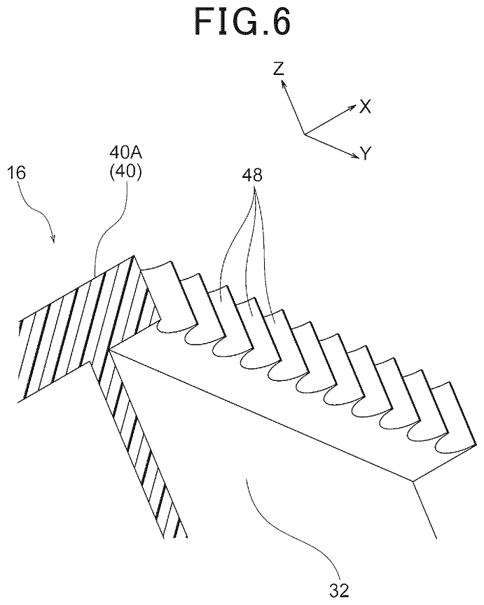

As shown in FIG. 6, in the protruding portion 40A, there are formed a plurality of grooves 48. The grooves 48 are aligned with each other in the Y direction. Each groove 48 penetrates the protruding portion 40A in the Z direction. The coil that forms the axial portion 34 described above is inserted in each of the grooves 48. Moreover, although not specifically shown in the drawings, in the protruding portion 40B, there are also formed a plurality of grooves 48 in the same manner as in the protruding portion 40A.

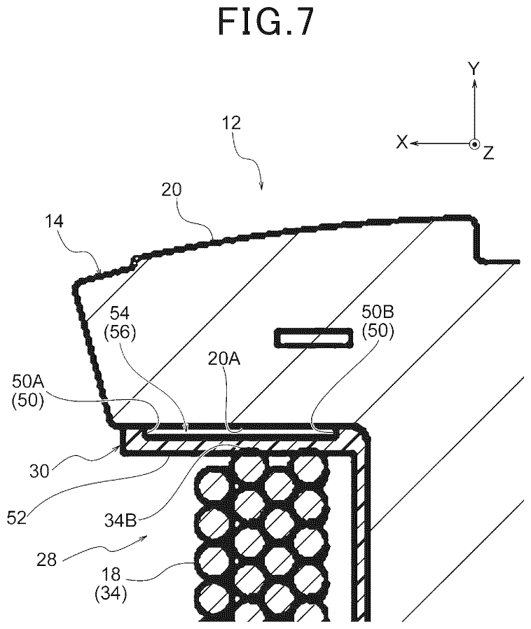

As shown in FIG. 7, the inner wall portion 30 of the insulator 16 extends in both the X and Z directions along the axial portion 34 of the coil winding part 18. The inner wall portion 30 includes a pair of protruding portions 50 and a resin portion 52. Of the pair of protruding portions 50, a protruding portion 50A is formed at one end of the inner wall portion 30 in the X direction, whereas a protruding portion 50B is formed at the other end of the inner wall portion 30 in the X direction. The resin portion 52 is formed of that part of the inner wall portion 30 which is located between the protruding portion 50A and the protruding portion 50B.

The pair of protruding portions 50 each protrude from the resin portion 52 toward the umbrella part 20 of the core member 14. Moreover, the pair of protruding portions 50 are each formed in the shape of a rib extending in the Z direction. Furthermore, the pair of protruding portions 50 each abut against the inner surface 20A of the umbrella part 20 of the core member 14, thereby forming a gap 54 between the resin portion 52 and the umbrella part 20. The gap 54 is filled with air; and an insulating layer 56 is formed by the air filled in the gap 54. Thus, between the inner surface 20A of the umbrella part 20 of the core member 14 and the end surface 34B of the axial portion 34 of the coil winding part 18, there is provided, in addition to the resin portion 52, the insulating layer 56 that is formed between the resin portion 52 and the umbrella part 20 of the core member 14. Both the resin portion 52 and the insulating layer 56 are provided in a corresponding one of the slots 28. The insulating layer 56 formed of air is an insulator which has a lower permittivity than the insulator 16.

In addition, the insulating layer 56 may be formed of any material which has a lower permittivity than the insulator 16, regardless of whether it is in the form of gas, fluid, or solid.

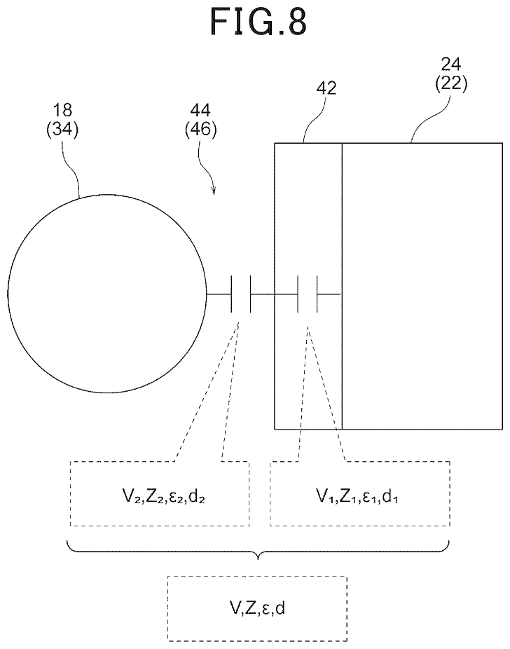

Referring to FIG. 8, the voltage division between the stator core 24 and the coil winding part 18 can be considered as follows. Specifically, as an example, the voltage division between the tooth part 22 of the core member 14 on which the coil winding part 18 is wound and the axial portion 34 of the coil winding part 18 will be considered hereinafter. In FIG. 8, V represents the voltage between the tooth part 22 and the axial portion 34; V₁ represents the voltage applied across the resin portion 42; V₂ represents the voltage applied across the insulating layer 46; Z represents the insulation resistance between the tooth part 22 and the axial portion 34; Z₁ represents the insulation resistance of the resin portion 42; Z₂ represents the insulation resistance of the insulating layer 46; ε represents the permittivity between the tooth part 22 and the axial portion 34; ε₁ represents the permittivity of the resin portion 42; ε₂ represents the permittivity of the insulating layer 46; d represents the distance between the tooth part 22 and the axial portion 34; d₁ represents the thickness of the resin portion 42; and d₂ represents the thickness of the insulating layer 46. Then, V₂ can be calculated by the following equation (1).

$${V}_{2} = \frac{{Z}_{1}}{{Z}_{1} + {Z}_{2}} V = \frac{{ε}_{1} {d}_{2}}{{ε}_{1} {d}_{2} + {ε}_{2} {d}_{1}} V \qquad ( 1 )$$

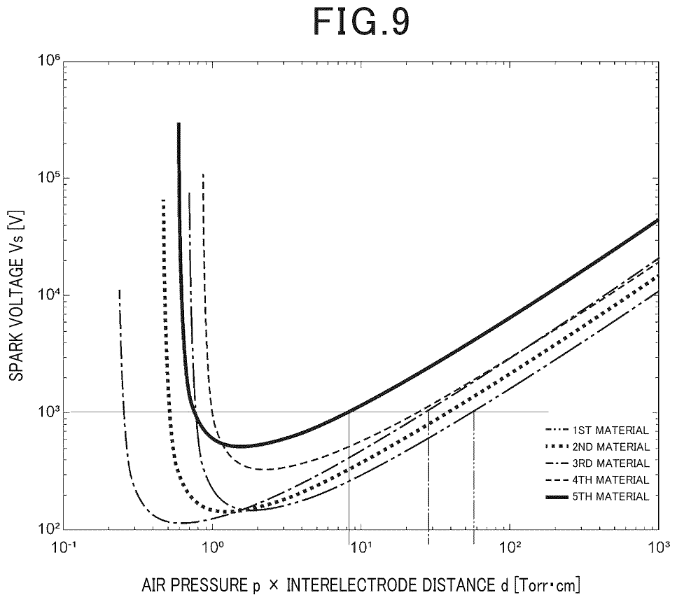

The voltage division is determined by the permittivities and thicknesses of the materials. In order to lower the voltage applied across the resin portion 42, insulation by a material whose permittivity is lower than that of the resin portion 42 is required. Therefore, the insulating distance of the material used for forming the insulating layer 46 is calculated based on the Paschen's curves shown in FIG. 9. Then, the insulation between the tooth part 22 and the axial portion 34 can be secured by the insulating layer 46 that has a thickness equivalent to the calculated insulation distance and a lower permittivity than the resin portion 42, thereby enabling reduction in the distance between the tooth part 22 and the axial portion 34.

Next, the operation and effects of the stator 10 according to the first embodiment will be described.

As described above in detail, in the first embodiment, as shown in FIGS. 3 to 6, between the side surface 22A of the tooth part 22 of the core member 14 and the side surface 34A of the axial portion 34 of the coil winding part 18, there are provided the insulating layer 46 as well as the resin portion 42. Consequently, insulation of the tooth part 22 of the core member 14 from the coil winding part 18 can be secured by both the resin portion 42 and the insulating layer 46.

Moreover, the insulating layer 46 is an insulator which has a lower permittivity than the insulator 16. Consequently, it becomes possible to shorten the distance between the side surface 22A of the tooth part 22 of the core member 14 and the side surface 34A of the axial portion 34 of the coil winding part 18 in comparison with the case of securing the insulation of the tooth part 22 of the core member 14 from the coil winding part 18 only by the resin portion 42.

In the first embodiment, both the resin portion 42 and the insulating layer 46 are provided in the corresponding slot 28. Consequently, it becomes possible to increase the cross-sectional area of the corresponding slot 28 by an amount resulting from the shortening of the distance between the side surface 22A of the tooth part 22 of the core member 14 and the side surface 34A of the axial portion 34 of the coil winding part 18 in comparison with the case of securing the insulation of the tooth part 22 of the core member 14 from the coil winding part 18 only by the resin portion 42. As a result, it becomes possible to increase the number of turns of the coil winding part 18.

In addition, in the case of securing the insulation of the tooth part 22 of the core member 14 from the coil winding part 18 only by the resin portion 42, it is necessary to increase the thickness of the resin portion 42 in comparison with the case of securing the insulation of the tooth part 22 of the core member 14 from the coil winding part 18 by both the resin portion 42 and the insulating layer 46. However, with increase in the thickness of the resin portion 42, the cross-sectional area of the corresponding slot 28 would be decreased; thus, the number of turns of the coil winding part 18 would be decreased. Further, with the decrease in the number of turns of the coil winding part 18, the torque constant of the motor would be decreased. In this case, to secure the torque constant of the motor, it is necessary to increase the number of the core sheets 38 forming the core member 14 and thus the lamination thickness of the stator core 24. However, with increase in the lamination thickness of the stator core 24, the size of the stator core 24 and thus the size of the entire stator 10 would be increased in the Z direction.

In contrast, in the stator 10 according to the first embodiment, the number of turns of the coil winding part 18 can be increased; thus, the torque constant of the motor can be secured without increasing the lamination thickness of the stator core 24. Consequently, it becomes possible to suppress increase in the size of the stator core 24 and thus increase in the size of the entire stator 10 in the Z direction.

In the first embodiment, the side wall portion 32 of the insulator 16 has the pair of protruding portions 40 that protrude from the resin portion 42 toward the axial portion 34 of the coil winding part 18. The gap 44 is formed between the resin portion 42 and the axial portion 34 of the coil winding part 18 due to the abutment of the pair of protruding portions 40 against the side surface 34A of the axial portion 34. The insulating layer 46 is formed of the air filled in the gap 44. Consequently, it becomes possible to form the insulating layer 46 with the simple configuration of providing the pair of protruding portions 40 in the side wall portion 32 of the insulator 16. As a result, it becomes possible to prevent the cost of the stator 10 from being increased due to complication of the configuration of the insulator 16.

Moreover, in the first embodiment, of the pair of protruding portions 40, the protruding portion 40A is formed at one end of the side wall portion 32 in the Z direction, whereas the protruding portion 40B is formed at the other end of the side wall portion 32 in the Z direction. Consequently, it becomes possible to secure the insulating layer 46 continuously between one end and the other end of the side wall portion 32 in the Z direction.

In the first embodiment, the insulating layer 46 is formed of air. Consequently, it becomes possible to reduce the cost of the stator 10 in comparison with the case of forming the insulating layer 46 using an insulating material.

Similarly, as shown in FIGS. 3 and 7, in the first embodiment, between the inner surface 20A of the umbrella part 20 of the core member 14 and the end surface 34B of the axial portion 34 of the coil winding part 18, there are provided the insulating layer 56 as well as the resin portion 52. Consequently, insulation of the umbrella part 20 of the core member 14 from the coil winding part 18 can be secured by both the resin portion 52 and the insulating layer 56.

Moreover, the insulating layer 56 is an insulator which has a lower permittivity than the insulator 16. Consequently, it becomes possible to shorten the distance between the inner surface 20A of the umbrella part 20 of the core member 14 and the end surface 34B of the axial portion 34 of the coil winding part 18 in comparison with the case of securing the insulation of the umbrella part 20 of the core member 14 from the coil winding part 18 only by the resin portion 52.

In the first embodiment, both the resin portion 52 and the insulating layer 56 are provided in the corresponding slot 28. Consequently, it becomes possible to increase the cross-sectional area of the corresponding slot 28 by an amount resulting from the shortening of the distance between the inner surface 20A of the umbrella part 20 of the core member 14 and the end surface 34B of the axial portion 34 of the coil winding part 18 in comparison with the case of securing the insulation of the umbrella part 20 of the core member 14 from the coil winding part 18 only by the resin portion 52. Hence, it becomes possible to increase the number of turns of the coil winding part 18; thus, the torque constant of the motor can be secured without increasing the lamination thickness of the stator core 24. As a result, it becomes possible to suppress increase in the size of the stator core 24 and thus increase in the size of the entire stator 10 in the Z direction.

In the first embodiment, the inner wall portion 30 of the insulator 16 has the pair of protruding portions 50 that protrude from the resin portion 52 toward the umbrella part 20 of the core member 14. The gap 54 is formed between the resin portion 52 and the umbrella part 20 of the core member 14 due to the abutment of the pair of protruding portions 50 against the inner surface 20A of the umbrella part 20. The insulating layer 56 is formed of the air filled in the gap 54. Consequently, it becomes possible to form the insulating layer 56 with the simple configuration of providing the pair of protruding portions 50 in the inner wall portion 30 of the insulator 16. As a result, it becomes possible to prevent the cost of the stator 10 from being increased due to complication of the configuration of the insulator 16.

Moreover, in the first embodiment, of the pair of protruding portions 50, the protruding portion 50A is formed at one end of the inner wall portion 30 in the X direction, whereas the protruding portion 50B is formed at the other end of the inner wall portion 30 in the X direction. Consequently, it becomes possible to secure the insulating layer 56 continuously between one end and the other end of the inner wall portion 30 in the X direction.

In the first embodiment, the insulating layer 56 is formed of air. Consequently, it becomes possible to reduce the cost of the stator 10 in comparison with the case of forming the insulating layer 56 using an insulating material.

### Second Embodiment

Next, a second embodiment of the present disclosure will be described.

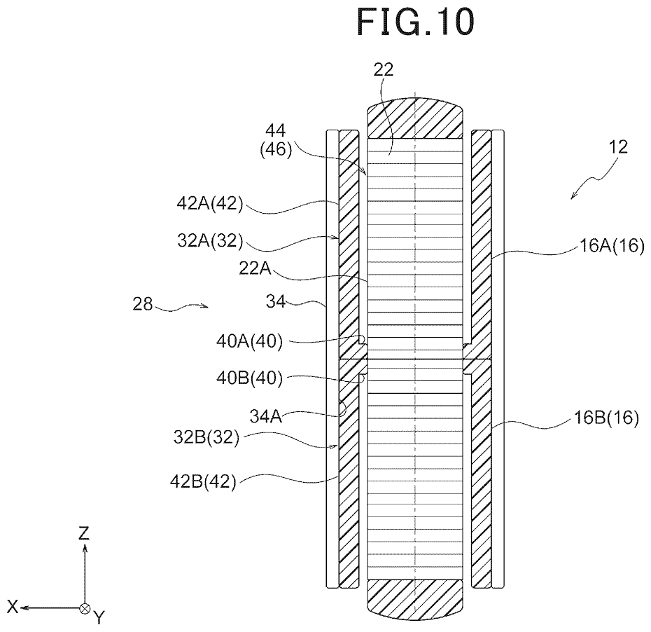

As shown in FIG. 10, in the second embodiment, the configuration of the insulator 16 is changed as follows compared to that in the first embodiment. Specifically, in the second embodiment, the pair of protruding portions 40 are formed at the center of the side wall portion 32 in the Z direction. The resin portion 42 is constituted of a first resin portion 42A and a second resin portion 42B. The first resin portion 42A is formed of that part of the first side wall portion 32A which is located closer than the protruding portion 40A to one end of the side wall portion 32 in the Z direction. On the other hand, the second resin portion 42B is formed by that part of the second side wall portion 32B which is located closer than the protruding portion 40B to the other end of the side wall portion 32 in the Z direction.

The pair of protruding portions 40 each protrude from the resin portion 42 toward the tooth part 22 of the core member 14. Moreover, the pair of protruding portions 40 each abut against the side surface 22A of the tooth part 22 of the core member 14, thereby forming a gap 44 between the resin portion 42 and the tooth part 22 of the core member 14. The gap 44 is filled with air; and an insulating layer 46 is formed by the air filled in the gap 44. Thus, between the side surface 22A of the tooth part 22 of the core member 14 and the side surface 34A of the axial portion 34 of the coil winding part 18, there is provided, in addition to the resin portion 42, the insulating layer 46 that is formed between the resin portion 42 and the tooth part 22 of the core member 14.

As described above, in the second embodiment, between the side surface 22A of the tooth part 22 of the core member 14 and the side surface 34A of the axial portion 34 of the coil winding part 18, there are provided the insulating layer 46 as well as the resin portion 42. Consequently, insulation of the tooth part 22 of the core member 14 from the coil winding part 18 can be secured by both the resin portion 42 and the insulating layer 46.

Moreover, the insulating layer 46 is an insulator which has a lower permittivity than the insulator 16. Consequently, it becomes possible to shorten the distance between the side surface 22A of the tooth part 22 of the core member 14 and the side surface 34A of the axial portion 34 of the coil winding part 18 in comparison with the case of securing the insulation of the tooth part 22 of the core member 14 from the coil winding part 18 only by the resin portion 42.

Furthermore, both the resin portion 42 and the insulating layer 46 are provided in the corresponding slot 28. Consequently, it becomes possible to increase the cross-sectional area of the corresponding slot 28 by an amount resulting from the shortening of the distance between the side surface 22A of the tooth part 22 of the core member 14 and the side surface 34A of the axial portion 34 of the coil winding part 18 in comparison with the case of securing the insulation of the tooth part 22 of the core member 14 from the coil winding part 18 only by the resin portion 42. Hence, it becomes possible to increase the number of turns of the coil winding part 18; thus, the torque constant of the motor can be secured without increasing the lamination thickness of the stator core 24. As a result, it becomes possible to suppress increase in the size of the stator core 24 and thus increase in the size of the entire stator 10 in the Z direction.

Furthermore, the side wall portion 32 of the insulator 16 has the pair of protruding portions 40 that protrude from the resin portion 42 toward the tooth part 22 of the core member 14. The gap 44 is formed between the resin portion 42 and the tooth part 22 of the core member 14 due to the abutment of the pair of protruding portions 40 against the side surface 22A of the tooth part 22 of the core member 14. The insulating layer 46 is formed of the air filled in the gap 44. Consequently, it becomes possible to form the insulating layer 46 with the simple configuration of providing the pair of protruding portions 40 in the side wall portion 32 of the insulator 16. As a result, it becomes possible to prevent the cost of the stator 10 from being increased due to complication of the configuration of the insulator 16.

Furthermore, the pair of protruding portions 40 are formed at the center of the side wall portion 32 in the Z direction. Consequently, the center of the side wall portion 32 in the Z direction can be supported by the pair of protruding portions 40 with respect to the side surface 22A of the tooth part 22 of the core member 14, thereby suppressing deflection of the side wall portion 32 toward the tooth part 22 of the core member 14.

### Third Embodiment

Next, a third embodiment of the present disclosure will be described.

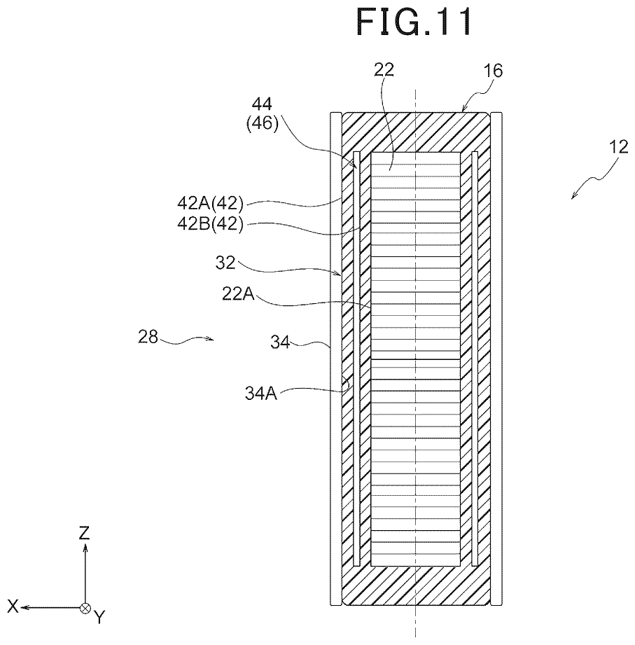

As shown in FIG. 11, in the third embodiment, the configuration of the insulator 16 is changed as follows compared to that in the first embodiment. Specifically, in the third embodiment, the resin portion 42 is constituted of a first resin portion 42A and a second resin portion 42B. The first resin portion 42A and the second resin portion 42B face each other in the X direction through an insulating layer 46 that is formed by a gap 44. Moreover, the first resin portion 42A is placed in intimate contact with the side surface 34A of the axial portion 34 of the coil winding part 18, while the second resin portion 42B is placed in intimate contact with the side surface 22A of the tooth part 22 of the core member 14. In addition, the gap 44 may be either closed or open to the outside of the side wall portion 32 of the insulator 16.

According to the third embodiment, the first resin portion 42A is placed in intimate contact with the side surface 34A of the axial portion 34 of the coil winding part 18, while the second resin portion 42B is placed in intimate contact with the side surface 22A of the tooth part 22 of the core member 14. With this configuration, it becomes possible to improve the stability of the axial portion 34 of the coil winding part 18 and the side wall portion 32 of the insulator 16 with respect to the tooth part 22 of the core member 14 in comparison with, for example, configurations where the axial portion 34 of the coil winding part 18 or the tooth part 22 of the core member 14 adjoins the gap 44.

### Fourth Embodiment

Next, a fourth embodiment of the present disclosure will be described.

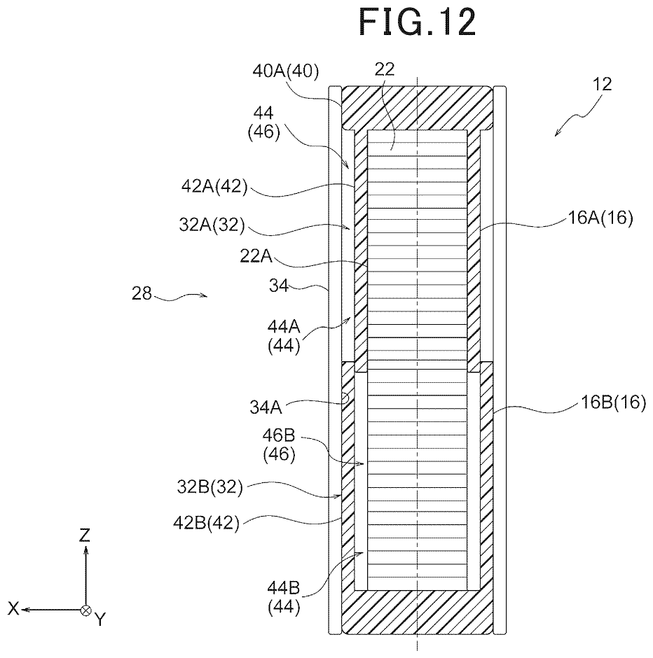

As shown in FIG. 12, in the fourth embodiment, the configuration of the insulator 16 is changed as follows compared to that in the first embodiment. Specifically, in the fourth embodiment, the second resin portion 42B of the resin portion 42 is provided in such a manner as to be offset from the first resin portion 42A of the resin portion 42 in both the X and Z directions. As an example, the second resin portion 42B is located closer than the first resin portion 42A to the axial portion 34 of the coil winding part 18.

Moreover, the first resin portion 42A is placed in intimate contact with the side surface 22A of the tooth part 22 of the core member 14, while the second resin portion 42B is placed in intimate contact with the side surface 34A of the axial portion 34 of the coil winding part 18. The insulating layer 46 is constituted of a first insulating layer 46A and a second insulating layer 46B. The first insulating layer 46A is formed by a first gap 44A that is formed between the first resin portion 42A and the side surface 34A of the axial portion 34 of the coil winding part 18. On the other hand, the second insulating layer 46B is formed by a second gap 44B that is formed between the second resin portion 42B and the side surface 22A of the tooth part 22 of the core member 14.

According to the fourth embodiment, the first resin portion 42A is placed in intimate contact with the side surface 22A of the tooth part 22 of the core member 14, while the second resin portion 42B is placed in intimate contact with the side surface 34A of the axial portion 34 of the coil winding part 18. With this configuration, it becomes possible to improve the stability of the axial portion 34 of the coil winding part 18 and the side wall portion 32 of the insulator 16 with respect to the tooth part 22 of the core member 14 in comparison with, for example, configurations where the axial portion 34 of the coil winding part 18 adjoins the gap 44 over the entire range from one end to the other end of the axial portion 34 or the tooth part 22 of the core member 14 adjoins the gap 44 over the entire range from one end to the other end of the tooth part 22.

In addition, in the fourth embodiment, the second resin portion 42B is located closer than the first resin portion 42A to the axial portion 34 of the coil winding part 18; however, the second resin portion 42B may alternatively be located closer than the first resin portion 42A to the tooth part 22 of the core member 14. Moreover, the first insulating layer 46A may alternatively be formed between the first resin portion 42A and the side surface 22A of the tooth part 22 of the core member 14; and the second insulating layer 46B may alternatively be formed between the second resin portion 42B and the side surface 34A of the axial portion 34 of the coil winding part 18.

### Fifth Embodiment

Next, a fifth embodiment of the present disclosure will be described.

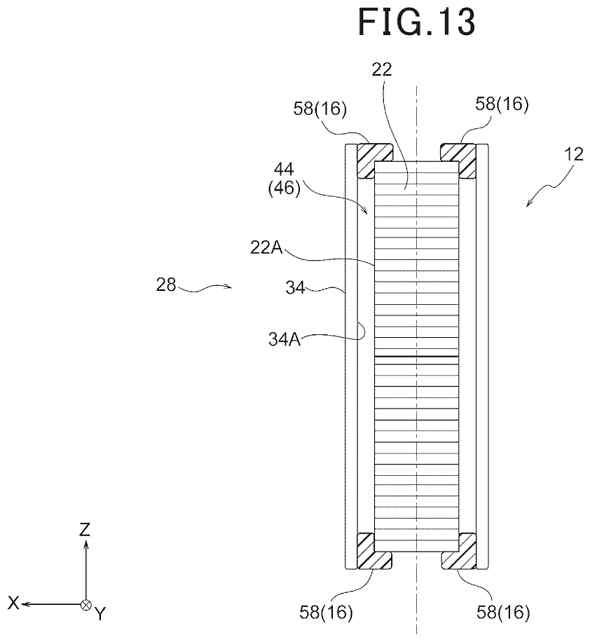

As shown in FIG. 13, in the fifth embodiment, the configuration of the insulator 16 is changed as follows compared to that in the first embodiment. Specifically, in the fifth embodiment, the insulator 16 has a plurality of corner parts 58. The tooth part 22 of the core member 14 is formed to have a quadrangular shape when viewed in the Y direction. The corner parts 58 of the insulator 16 are provided respectively on corner portions of the quadrangular shape of the tooth part 22 of the core member 14. On each side of the stator constituent member 12 in the X direction, there is formed, by a pair of the corner parts 58 aligned in the Z direction, a gap 44 between the side surface 22A of the tooth part 22 of the core member 14 and the side surface 34A of the axial portion 34 of the coil winding part 18. The gap 44 is filled with air; and an insulating layer 46 is formed by the air filled in the gap 44.

According to the fifth embodiment, the insulating layer 46, which is an insulator having a lower permittivity than the insulator 16, is provided between the side surface 22A of the tooth part 22 of the core member 14 and the side surface 34A of the axial portion 34 of the coil winding part 18. Consequently, it becomes possible to shorten the distance between the side surface 22A of the tooth part 22 of the core member 14 and the side surface 34A of the axial portion 34 of the coil winding part 18 in comparison with the case of securing the insulation of the tooth part 22 of the core member 14 from the coil winding part 18 only by the insulator 16.

### Sixth Embodiment

Next, a sixth embodiment of the present disclosure will be described.

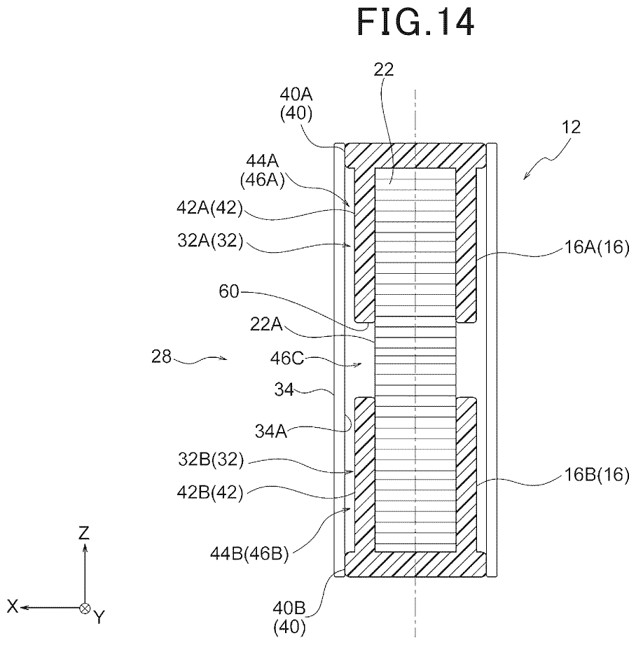

As shown in FIG. 14, in the sixth embodiment, the configuration of the insulator 16 is changed as follows compared to that in the first embodiment. Specifically, in the sixth embodiment, a gap 60 is formed between the first side wall portion 32A and the second side wall portion 32B in the Z direction. Moreover, a first insulating layer 46A is formed by a first gap 44A between the first resin portion 42A and the axial portion 34 of the coil winding part 18. A second insulating layer 46B is formed by a second gap 44B between the second resin portion 42B and the axial portion 34 of the coil winding part 18. A third insulating layer 46C is formed between a central part of the side surface 22A of the tooth part 22 of the core member 14 in the Z direction and a central part of the side surface 34A of the axial portion 34 of the coil winding part 18 in the Z direction.

According to the sixth embodiment, between the central part of the side surface 22A of the tooth part 22 of the core member 14 in the Z direction and the central part of the side surface 34A of the axial portion 34 of the coil winding part 18 in the Z direction, there is provided only the third insulating layer 46C that has a lower permittivity than the insulator 16. Consequently, it becomes possible to more reliably secure insulation between the central part of the side surface 22A of the tooth part 22 of the core member 14 in the Z direction and the central part of the side surface 34A of the axial portion 34 of the coil winding part 18 in the Z direction in comparison with the case of providing the resin portion 42 therebetween.

### Seventh Embodiment

Next, a seventh embodiment of the present disclosure will be described.

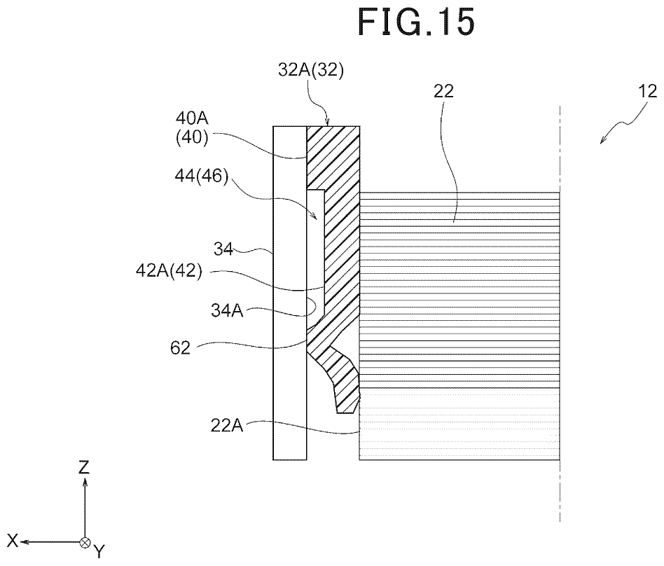

As shown in FIG. 15, in the seventh embodiment, the configuration of the side wall portion 32 is changed as follows compared to that in the first embodiment. It should be noted that FIG. 15 shows one side of the first side wall portion 32A. In the seventh embodiment, the first side wall portion 32A includes a support portion 62. The support portion 62 is formed in the first resin portion 42A. Specifically, the support portion 62 is formed by bending a part of the first resin portion 42A toward the axial portion 34 of the coil winding part 18. The support portion 62 abuts against the side surface 34A of the axial portion 34 of the coil winding part 18 and supports the axial portion 34 of the coil winding part 18 with respect to the side surface 22A of the tooth part 22 of the core member 14.

According to the seventh embodiment, the axial portion 34 of the coil winding part 18 is supported by the support portion 62 with respect to the side surface 22A of the tooth part 22 of the core member 14. Consequently, it becomes possible to suppress deflection of the axial portion 34 of the coil winding part 18 toward the tooth part 22 of the core member 14 in comparison with the case of no support portion being provided to support the axial portion 34 of the coil winding part 18.

In addition, although not specifically shown in the drawings, the second side wall portion 32B may also be formed in the same manner as the first side wall portion 32A.

### Eighth Embodiment

Next, an eighth embodiment of the present disclosure will be described.

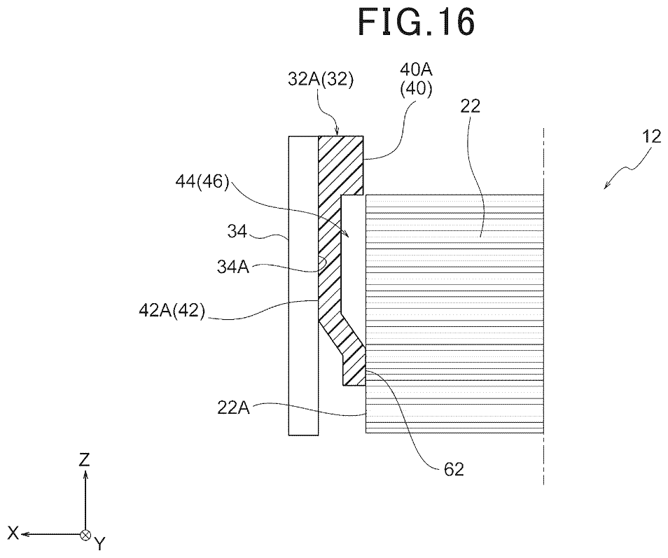

As shown in FIG. 16, in the eighth embodiment, the configuration of the side wall portion 32 is changed as follows compared to that in the first embodiment. It should be noted that FIG. 16 shows one side of the first side wall portion 32A. In the eighth embodiment, the protruding portion 40A protrudes from the first resin portion 42A toward the tooth part 22 of the core member 14. An insulating layer 46 is formed by a gap 44 between the first resin portion 42A and the side surface 22A of the tooth part 22 of the core member 14.

The first side wall portion 32A includes a support portion 62. The support portion 62 is formed in the first resin portion 42A. Specifically, the support portion 62 is formed by bending a part of the first resin portion 42A toward the tooth part 22 of the core member 14. The support portion 62 abuts against the side surface 22A of the tooth part 22 of the core member 14 and supports the axial portion 34 of the coil winding part 18 with respect to the side surface 22A of the tooth part 22 of the core member 14.

According to the eighth embodiment, the axial portion 34 of the coil winding part 18 is supported by the support portion 62 with respect to the side surface 22A of the tooth part 22 of the core member 14. Consequently, it becomes possible to suppress deflection of the axial portion 34 of the coil winding part 18 toward the tooth part 22 of the core member 14 in comparison with the case of no support portion being provided to support the axial portion 34 of the coil winding part 18.

In addition, although not specifically shown in the drawings, the second side wall portion 32B may also be formed in the same manner as the first side wall portion 32A.

### Ninth Embodiment

Next, a ninth embodiment of the present disclosure will be described.

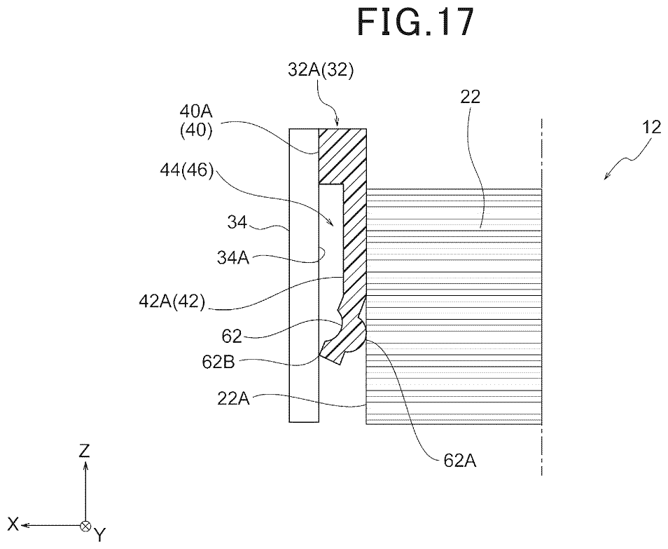

As shown in FIG. 17, in the ninth embodiment, the configuration of the side wall portion 32 is changed as follows compared to that in the seventh embodiment. It should be noted that FIG. 17 shows one side of the first side wall portion 32A. In the ninth embodiment, the support portion 62 is formed in a tapered shape such that it is inclined toward the axial portion 34 of the coil winding part 18 as it extends from one end side to the other end side of the first side wall portion 32 in the Z direction.

The support portion 62 includes a curved portion 62A that is formed by bending a part of the support portion 62. The curved portion 62A abuts against the side surface 22A of the tooth part 22 of the core member 14. Moreover, the support portion 62 has a free end 62B that abuts against the side surface 34A of the axial portion 34 of the coil winding part 18. Consequently, the axial portion 34 of the coil winding part 18 is supported by the support portion 62 with respect to the side surface 22A of the tooth part 22 of the core member 14.

According to the ninth embodiment, the support portion 62 is formed in a tapered shape. Consequently, it becomes possible to prevent the support portion 62 from getting caught on the tooth part 22 of the core member 14 when the first insulator 16A (see FIG. 5) is mounted to the tooth part 22 from the support portion 62 side. As a result, it becomes possible to improve the work efficiency when the first insulator 16A is mounted to the tooth part 22.

In addition, although not specifically shown in the drawings, the second side wall portion 32B may also be formed in the same manner as the first side wall portion 32A.

Next, common modifications to the above-described embodiments will be described.

In the above-described embodiments, an insulating layer 46 and a configuration for forming the insulating layer 46 are provided for the axial portion 34 of the coil winding part 18. However, an insulating layer 46 and a configuration for forming the insulating layer 46 may also be provided for the tangential portion 36 of the coil winding part 18.

In the above-described embodiments, the stator core 24 is divided into a plurality of core members 14; however, the plurality of core members 14 may be integrated into one piece. Moreover, in the above-described embodiments, the stator 10 has a plurality of first insulators 16A each of which is mounted to one of the core members 14; however, the plurality of first insulators 16A may be integrated into one piece. Similarly, in the above-described embodiments, the stator 10 has a plurality of second insulators 16B each of which is mounted to one of the core members 14; however, the plurality of second insulators 16B may be integrated into one piece.

The above-described embodiments can also be implemented in combination with each other to the extent that there is no technical contradiction between them. While the present disclosure has been described pursuant to the above-described embodiments, it should be appreciated that the present disclosure is not limited to the above-described embodiments, but can also be implemented through various modifications to the above-described embodiments without departing from the gist of the present disclosure.

The following notes summarize the technology according to the present disclosure.

### (First Note)

A stator (10) comprising:
a stator core (24) having a plurality of tooth parts (22) extending in a radial fashion;
insulators (16) formed of resin and mounted to the stator core; and
coil winding parts (18) each of which is wound on a corresponding one of the tooth parts of the stator core via a corresponding one of the insulators,
wherein
between the stator core and each of the coil winding parts, there is provided an insulating layer (46, 56) that has a lower permittivity than the insulators.

### (Second Note)

The stator according to the first note, wherein between the stator core and each of the coil winding parts, there are provided both a resin portion (42, 52), which is formed in the corresponding insulator, and the insulating layer.

### (Third Note)

The stator according to the second note, wherein:
slots (28) are formed between the tooth parts of the stator core; and
both the resin portion and the insulating layer are provided in a corresponding one of the slots.

### (Fourth Note)

The stator according to the third note, wherein:
each of the insulators has a protruding portion (40, 50) that protrudes from the resin portion of the insulator toward the corresponding coil winding part or toward the stator core; and
the insulating layer is provided in a gap (44, 54) that is formed between the stator core and the corresponding coil winding part due to abutment of the protruding portion of the corresponding insulator against the corresponding coil winding part or against the stator core.

### (Fifth Note)

The stator according to the fourth note, wherein:
each of the coil winding parts has an axial portion (34) inserted in a corresponding one of the slots and extending in an axial direction of the stator core;
each of the insulators has a side wall portion (32) that includes the resin portion and extends along the axial portion of the corresponding coil winding part;
for each of the insulators, the protruding portion is formed in the side wall portion of the insulator and protrudes from the resin portion toward the axial portion of the corresponding coil winding part; and
the gap is formed between the resin portion of the corresponding insulator and the axial portion of the corresponding coil winding part.

### (Sixth Note)

The stator according to the fifth note, wherein for each of the insulators, the protruding portion is formed at an end of the side wall portion of the insulator in the axial direction.

### (Seventh Note)

The stator according to the fourth note, wherein:
each of the coil winding parts has an axial portion inserted in a corresponding one of the slots and extending in an axial direction of the stator core;
each of the insulators has a side wall portion that includes the resin portion and extends along the axial portion of the corresponding coil winding part;
each of the tooth parts of the stator core has a side surface (22A) that adjoins a corresponding one of the slots;
for each of the insulators, the protruding portion is formed in the side wall portion of the insulator and protrudes from the resin portion toward the side surface of the corresponding tooth part of the stator core; and
the gap is formed between the resin portion of the corresponding insulator and the side surface of the corresponding tooth part of the stator core.

### (Eighth Note)

The stator according to the seventh note, wherein for each of the insulators, the protruding portion is formed at a center of the side wall portion of the insulator in the axial direction.

### (Ninth Note)

The stator according to any one of the fifth to eighth notes, wherein:
each of the tooth parts of the stator core has a side surface that adjoins a corresponding one of the slots; and
in each of the insulators, the side wall portion further includes a support portion (62) that supports the axial portion of the corresponding coil winding part with respect to the side surface of the corresponding tooth part of the stator core.

### (Tenth Note)

The stator according to the ninth note, wherein the support portion is formed in a tapered shape.

### (Eleventh Note)

The stator according to the third note, wherein:
each of the coil winding parts has an axial portion inserted in a corresponding one of the slots and extending in an axial direction of the stator core; and
the resin portion is constituted of a first resin portion (42A) and a second resin portion (42B) that faces the first resin portion through the insulating layer.

### (Twelfth Note)

The stator according to the third note, wherein:
each of the coil winding parts has an axial portion inserted in a corresponding one of the slots and extending in an axial direction of the stator core;
each of the tooth parts of the stator core has a side surface (22A) that adjoins a corresponding one of the slots;
the resin portion is constituted of a first resin portion (42A) and a second resin portion (42B) that is offset from the first resin portion in the axial direction; and
the insulating layer is constituted of a first insulating layer (46A) provided between the first resin portion and the axial portion of the corresponding coil winding part and a second insulating layer (46B) provided between the second resin portion and the side surface of the corresponding tooth part of the stator core.

### (Thirteenth Note)

The stator according to the first note, wherein:
between the stator core and each of the coil winding parts, there is formed a gap by the corresponding insulator; and
the insulating layer is provided in the gap.

### (Fourteenth Note)

The stator according to any one of the first to thirteenth notes, wherein the insulating layer is formed of air.

What is claimed is:

1. A stator comprising:
a stator core having a plurality of tooth parts extending in a radial fashion;
insulators formed of resin and mounted to the stator core; and
coil winding parts each of which is wound on a corresponding one of the tooth parts of the stator core via a corresponding one of the insulators,
wherein
between the stator core and each of the coil winding parts, there is provided an insulating layer that has a lower permittivity than the insulators.

2. The stator as set forth in claim 1, wherein between the stator core and each of the coil winding parts, there are provided both a resin portion, which is formed in the corresponding insulator, and the insulating layer.

3. The stator as set forth in claim 2, wherein:
slots are formed between the tooth parts of the stator core; and
both the resin portion and the insulating layer are provided in a corresponding one of the slots.

4. The stator as set forth in claim 3, wherein:
each of the insulators has a protruding portion that protrudes from the resin portion of the insulator toward the corresponding coil winding part or toward the stator core; and
the insulating layer is provided in a gap that is formed between the stator core and the corresponding coil winding part due to abutment of the protruding portion of the corresponding insulator against the corresponding coil winding part or against the stator core.

5. The stator as set forth in claim 4, wherein:
each of the coil winding parts has an axial portion inserted in a corresponding one of the slots and extending in an axial direction of the stator core;
each of the insulators has a side wall portion that includes the resin portion and extends along the axial portion of the corresponding coil winding part;
for each of the insulators, the protruding portion is formed in the side wall portion of the insulator and protrudes from the resin portion toward the axial portion of the corresponding coil winding part; and
the gap is formed between the resin portion of the corresponding insulator and the axial portion of the corresponding coil winding part.

6. The stator as set forth in claim 5, wherein for each of the insulators, the protruding portion is formed at an end of the side wall portion of the insulator in the axial direction.

7. The stator as set forth in claim 5, wherein:
each of the tooth parts of the stator core has a side surface that adjoins a corresponding one of the slots; and
in each of the insulators, the side wall portion further includes a support portion that supports the axial portion of the corresponding coil winding part with respect to the side surface of the corresponding tooth part of the stator core.

8. The stator as set forth in claim 7, wherein the support portion is formed in a tapered shape.

9. The stator as set forth in claim 4, wherein:
each of the coil winding parts has an axial portion inserted in a corresponding one of the slots and extending in an axial direction of the stator core;
each of the insulators has a side wall portion that includes the resin portion and extends along the axial portion of the corresponding coil winding part;
each of the tooth parts of the stator core has a side surface that adjoins a corresponding one of the slots;
for each of the insulators, the protruding portion is formed in the side wall portion of the insulator and protrudes from the resin portion toward the side surface of the corresponding tooth part of the stator core; and
the gap is formed between the resin portion of the corresponding insulator and the side surface of the corresponding tooth part of the stator core.

10. The stator as set forth in claim 9, wherein for each of the insulators, the protruding portion is formed at a center of the side wall portion of the insulator in the axial direction.

11. The stator as set forth in claim 9, wherein:
each of the tooth parts of the stator core has a side surface that adjoins a corresponding one of the slots; and
in each of the insulators, the side wall portion further includes a support portion that supports the axial portion of the corresponding coil winding part with respect to the side surface of the corresponding tooth part of the stator core.

12. The stator as set forth in claim 11, wherein the support portion is formed in a tapered shape.

13. The stator as set forth in claim 3, wherein:
each of the coil winding parts has an axial portion inserted in a corresponding one of the slots and extending in an axial direction of the stator core; and
the resin portion is constituted of a first resin portion and a second resin portion that faces the first resin portion through the insulating layer.

14. The stator as set forth in claim 3, wherein:
each of the coil winding parts has an axial portion inserted in a corresponding one of the slots and extending in an axial direction of the stator core;
each of the tooth parts of the stator core has a side surface that adjoins a corresponding one of the slots;
the resin portion is constituted of a first resin portion and a second resin portion that is offset from the first resin portion in the axial direction; and
the insulating layer is constituted of a first insulating layer provided between the first resin portion and the axial portion of the corresponding coil winding part and a second insulating layer provided between the second resin portion and the side surface of the corresponding tooth part of the stator core.

15. The stator as set forth in claim 1, wherein:
between the stator core and each of the coil winding parts, there is formed a gap by the corresponding insulator; and
the insulating layer is provided in the gap.

16. The stator as set forth in claim 1, wherein the insulating layer is formed of air.
